(19) United States
(12) Patent Application Publication
(10) Pub. No.: US 2026/0200414 A1
(43) Pub. Date: Jul. 16, 2026

(54) RETAINER ASSEMBLIES FOR VEHICLE WIRE HARNESSES

(71) Applicant: Ford Global Technologies, LLC, Dearborn, MI (US)

(72) Inventors: Josue Israel Hernandez, CUAUTITLAN IZCALLI (MX); Emmanuelle Correa, Mexico City (MX)

(73) Assignee: Ford Global Technologies, LLC, Dearborn, MI (US)

(21) Appl. No.: 19/025,233

(22) Filed: Jan. 16, 2025

(51) Int. Cl. B60R 16/02; H02G 3/04

(52) U.S. Cl. CPC B60R 16/0215; H02G 3/0456

(57) ABSTRACT

A wire harness retainer assembly including a harness sliding structural member and a plurality of pressing support structural members is disclosed. The harness sliding structural member may have an elongated body with an arc-shaped cross section. The elongated body may include a hollow interior portion and open proximal and distal ends. Further, the pressing support structural members may be formed on the elongated body. Each pressing support structural member may include a concave-shaped body curved inwards towards the hollow interior portion. The elongated body may be configured to enable the wire harness to slide along an elongated body longitudinal axis, and the concave-shaped body of each pressing support structural member may be configured to press and apply an inward pressure on a wire harness circumference to secure the wire harness in the hollow interior portion.

### FIELD

The present disclosure relates to retainer assemblies for vehicle wire harnesses and more specifically to wire harness retainer assemblies providing sliding and pressing features.

### BACKGROUND

Modern vehicles include a plurality of wires that provide electric power to various vehicle systems and enable communication of electrical signals between these systems. The wires are typically “bundled” in wire harnesses that organize and direct the wire bundles to different parts of the vehicle body.

The wire harnesses are generally installed or connected to the vehicle body or one or more vehicle components (e.g., brackets, sheet metal, etc.) via retainers. Conventional retainers rigidly lock the wire harnesses, which may make it challenging to make any adjustments to the wire harnesses post installation.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example wire harness retainer assembly and a wire harness in accordance with the present disclosure.

FIG. 2 depicts an isometric view of an example wire harness retainer assembly in accordance with the present disclosure.

FIG. 3 depicts an enlarged view of a portion of the wire harness retainer assembly of FIG. 2 in accordance with the present disclosure.

FIG. 4 depicts a bottom view of the wire harness retainer assembly of FIG. 2 in accordance with the present disclosure.

FIG. 5 depicts a top view of the wire harness retainer assembly of FIG. 2 in accordance with the present disclosure.

FIG. 6 depicts a side view of the wire harness retainer assembly of FIG. 2 in accordance with the present disclosure.

FIG. 7 depicts a flow diagram of an example method to install a wire harness retainer assembly in accordance with the present disclosure.

### DETAILED DESCRIPTION

### Overview

The present disclosure describes a wire harness retainer assembly (“assembly”) that may be attached to a vehicle body and/or an external component (e.g., a bracket, sheet metal, etc.). The assembly may secure a wire harness, which may include a bundle of wires/cables that may be used to provide electric power to various vehicle systems and enable communication of electrical signals between these systems. The assembly may further enable an operator to conveniently slide the wire harness in the assembly's elongated body, while at the same time preventing “free” sliding of the wire harness by using the assembly's pressing features that restrict free wire harness movement within the elongated body.

The assembly may include an elongated body that may have an arc-shaped cross section. The elongated body may include a hollow interior portion (in which the wire harness may slide) and open proximal and distal ends. The elongated body may enclose the wire harness (when the operator inserts the wire harness into the elongated body via the elongated body's open proximal or distal end) and enable the wire harness to slide along an elongated body longitudinal axis.

The assembly may further include a plurality of pressing support structural members formed on the elongated body. Each pressing support structural member may include a concave-shaped body curved inwards towards the hollow interior portion. The concave-shaped body may be configured to “press” and apply an inward pressure on a wire harness circumference to secure the wire harness in the hollow interior portion and prevent free sliding of the wire harness within the elongated body. The concave-shaped body may have a smooth surface, which may ensure that the wire harness's condition (or the condition of the wires bundled in the wire harness) is not adversary affected when the operator slides the wire harness in the elongated body and the wire harness circumference touches the concave-shaped body.

In further aspects, the assembly may include one or more additional components that may enhance the operator's experience of using the assembly. For example, the assembly may include an attachment support structural member and one or more straps. An attachment support structural member's proximal edge may be attached to one elongated edge (e.g., a first elongated edge) of the elongated body, and an attachment support structural member's distal edge may include one or more receptacle structural members.

Further, the proximal ends of the straps may be attached to another elongated edge (e.g., a second elongated edge) of the elongated body. The receptacle structural members may be configured to receive the straps'distal ends and lock the straps. The straps may enable the elongated body to tightly secure the wire harness in the elongated body's hollow interior portion when the straps are locked in the receptacle structural members. In this manner, the assembly enables the operator to secure the wire harness in the assembly's elongated body.

In some aspects, the attachment support structural member has a planar body, which may include a through-hole configured to receive a fastener (which may be, for example, round, oval or Christmas tree retainer or clip or any other type of fastener) that may attach the assembly to the vehicle body or the external component. In an exemplary aspect, the through-hole may be present in the planar body's center portion.

During operation, an operator may first insert the fastener into the through-hole of the attachment support structural member. The operator may then slide the wire harness into the elongated body's hollow interior portion to an optimal position. Once the wire harness is in the optimal position, the operator may secure the wire harness in the elongated body by inserting and locking the straps in the receptacle structural members.

In some aspects, the operator may attach the assembly to the vehicle body/external components via the fastener after sliding the wire harness in the elongated body to the optimal position. In other aspects, the operator may first attach the assembly to the vehicle body/external components via the fastener and then slide the wire harness in the elongated body to the optimal position.

The present disclosure discloses a wire harness retainer assembly that provides many advantages over conventional wire harness retainer assemblies. For example, the assembly ensures that the wire harness is not too tightly secured in the elongated body, thereby ensuring that the wire harness or the wires are not adversely affected (e.g., due to short circuits or electricity discontinuities). This further increases harness durability during the vehicle's lifecycle. The assembly's sliding feature ensures that manufacturing tolerances are efficiently compensated, and the operator can conveniently slide the wire harness inside the elongated body as per the actual installation requirements/position. Further, the assembly can be easily adapted to secure wire harnesses of different diameters/sizes. Furthermore, any commercial retainer/fastener such as round, oval, Christmas tree retainer, etc. can be used to fix/attach the assembly to any kind of bracket according to the application.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

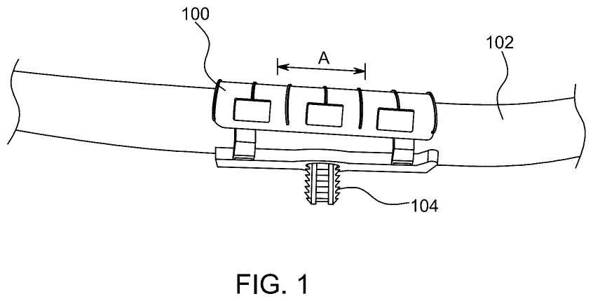

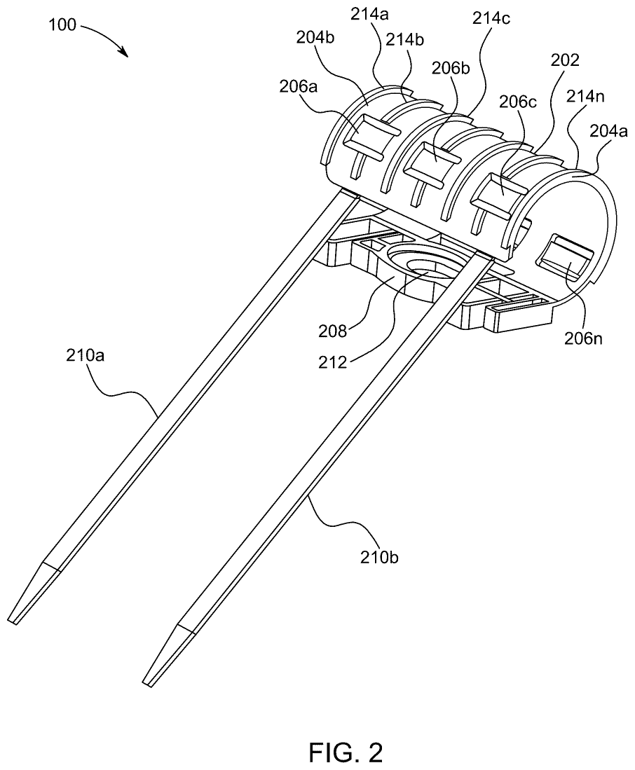

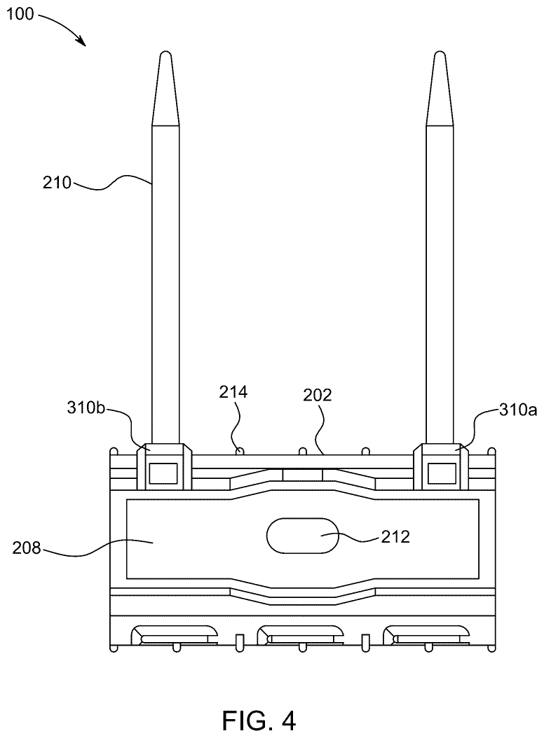

FIG. 1 depicts an example wire harness retainer assembly 100 (or assembly 100) and a wire harness 102 in accordance with the present disclosure. FIG. 1 will be described in conjunction with FIGS. 2-6.

The wire harness 102 may be a collection of wires or cables that may be bundled together in a single, organized unit. The wire harness 102 may be installed in a vehicle (not shown), and the wires included in the wire harness 102 may be used to provide electric power to various vehicle systems and enable communication of electrical signals between these vehicle systems. The vehicle may include a plurality of wire harnesses that may be installed at different vehicle body locations.

The wire harness 102 may be installed or connected to the vehicle body or an external component (e.g., a bracket, sheet metal, etc.) via the assembly 100 and one or more fasteners 104 (which may be, for example, round, oval or Christmas tree retainer or clip or any other type of fastener). In some aspects, the assembly 100 may be connected to the vehicle body or the external component via the fastener 104, and then the wire harness 102 may be secured in the assembly 100, thereby installing/connecting the wire harness 102 to the vehicle body/component. In other aspects, the wire harness 102 may be first secured in the assembly 100, and then the assembly 100 may be connected to the vehicle body or the external component via the fastener 104.

It is known that conventional retainer assemblies tightly and rigidly secure the wire harnesses, which may affect the performance of the wires bundled in the wire harnesses and may even render one or more wires in inoperable states. This affects the wire harnesses' long-term durability. Further, wire harness routing and retention in a vehicle require some level of “flexibility” during installation to compensate for manufacturing tolerances. It becomes difficult to make any adjustments to the wire harnesses post installation when the retainer assemblies tightly and rigidly secure the wire harnesses, as is the case with the conventional retainer assemblies.

The present disclosure discloses an optimized structure of a wire harness retainer assembly (e.g., the assembly 100), which overcomes the challenges associated with the conventional retainer assemblies described above. The assembly 100, as disclosed in the present disclosure, may include a harness sliding structural member having an elongated body 202 (as shown in FIGS. 2-6). The elongated body 202 may be made of a flexible material, e.g., plastic or any other similar material.

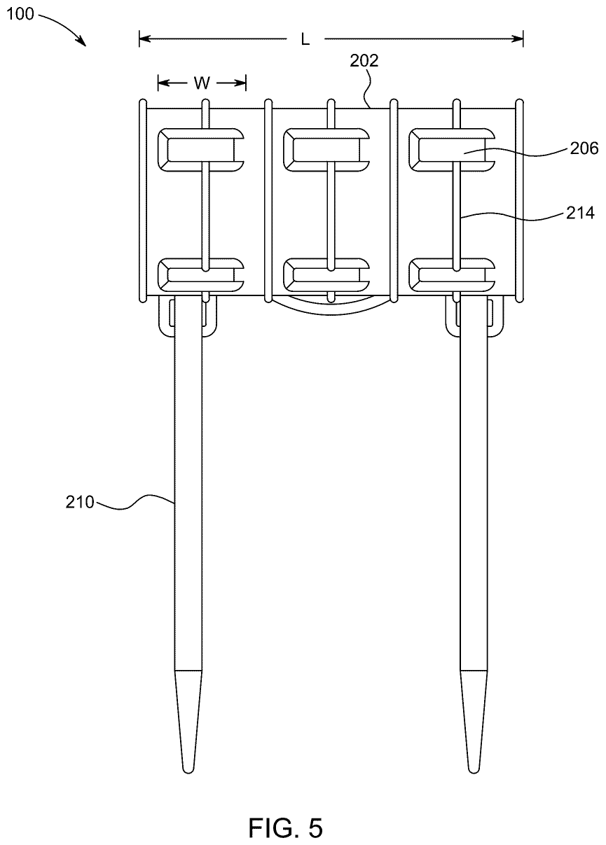

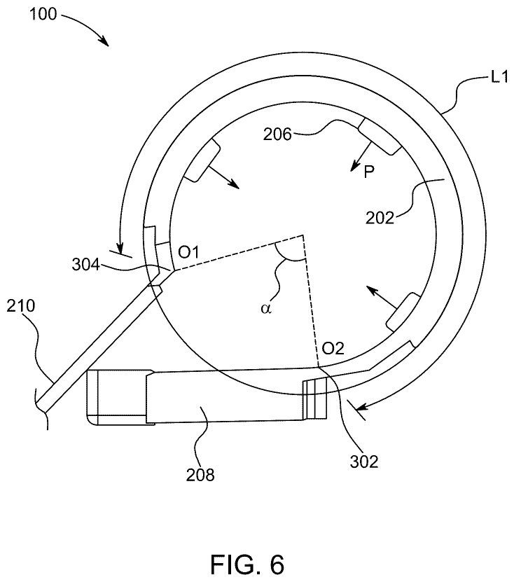

The elongated body 202 may have an arc-shaped cross section, with a hollow interior portion and open proximal and distal ends 204a, 204b. An elongated body's length “L” (as shown in FIG. 5) may be in a range of 2-6 inches. Further, the arc-shaped cross section may have a circumferential length “L1” (as shown in FIG. 6) that may be equivalent to 60-90% of a complete circular circumference. Stated another way, the arc-shaped cross section may cover 60-90% of the circumference of a complete circle. In some aspects, the elongated body 202 may include a first elongated edge 302 and a second elongated edge 304 that may be aligned parallel to each other. The first elongated edge 302 and the second elongated edge 304 may together form an angle “α” along imaginary lines “O1” and “O2” that connect respective elongated edges to a center point of the arc-shaped cross section, as shown in FIG. 6. In an exemplary aspect, the angle “α” may be in a range of 35-140 degrees. Further, in some aspects, an arc-shaped cross section's diameter may be in a range of 30-35 mm. In other aspects, the arc-shaped cross section's diameter may be more or less than the range described above and/or may be based on a diameter of the wire harness 102.

The elongated body 202 may be configured to enclose the wire harness 102 (as shown in FIG. 1) and enable the wire harness 102 to slide laterally (shown by an arrow “A” in FIG. 1) along an elongated body longitudinal axis. In some aspects, the elongated body 202 enables an operator to conveniently slide the wire harness 102 in the elongated body's hollow interior portion and secure the wire harness 102 in the elongated body 202 after the wire harness 102 has reached an optimal position in the elongated body 202. This facilitates the operator to efficiently install the wire harness 102 in the vehicle, taking into account some manufacturing tolerances. For example, if the operator is required to move slightly (left or right) the wire harness 102 after installing the assembly 100 to the vehicle body (or an external component such as a bracket) due to minor manufacturing tolerances, the operator may conveniently do so by sliding the wire harness 102 in the elongated body 202. In some aspects, the elongated body's diameter may be substantially equivalent to the diameter of the wire harness 102, so that while the wire harness 102 may slide in the elongated body's hollow interior portion, it may not slide “freely”.

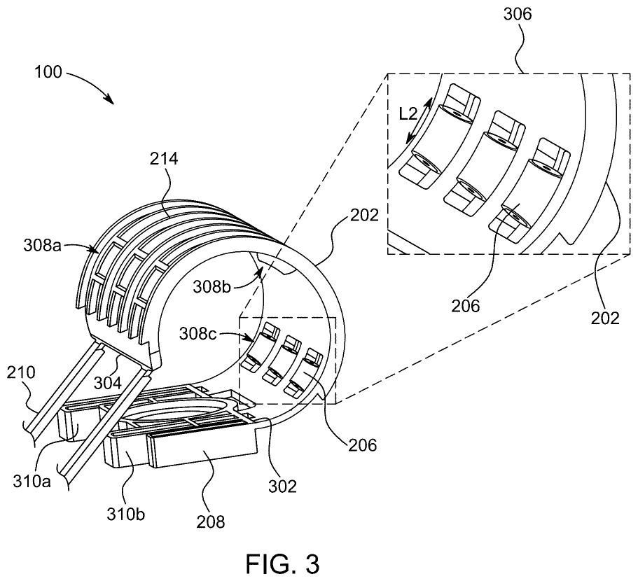

The assembly 100 may further include a plurality of pressing support structural members 206a, 206b, 206c, 206n (collectively referred to as pressing support structural members 206) formed on the elongated body 202, as shown in FIG. 2. Each pressing support structural member 206 may include a concave-shaped body curved inwards towards the hollow interior portion of the elongated body 202, as shown in a view 306 of FIG. 3. In some aspects, each pressing support structural member 206 may have a length “L2” (shown in FIG. 3) that may be in a range of 5-15% of the circumferential length “L1” of arc-shaped cross section associated with the elongated body 202. Further, a width “W” (shown in FIG. 5) of each pressing support structural member 206 may be in a range of 5-25% of the elongated body length “L”.

The concave-shaped body of each pressing support structural member 206 may be configured to “press” and apply an inward pressure (shown by arrows “P” in FIG. 6) on a wire harness circumference to secure the wire harness 102 in the elongated body's hollow interior portion. Specifically, when the wire harness 102 is placed inside the elongated body 202, the pressing support structural members 206 may press the wire harness 102 in an axially inward direction, to prevent free movement or slide of the wire harness 102 in the elongated body's hollow interior portion. Further, in some aspects, the surface of each pressing support structural member 206 is smooth, which ensures that the condition of the wire harness 102 is not affected when the pressing support structural members 206 apply the inward pressure on the wire harness 102 and/or when the operator slides the wire harness 102 in the elongated body 202.

In some aspects, the pressing support structural members 206 may be organized or disposed on the elongated body 202 in one or more sets. For example, as shown in FIG. 3, the assembly 100 may include a first set 308a, a second set 308b and a third set 308c of the pressing support structural members 206. Each set 308a, 308b, 308c of pressing support structural members may include one or more pressing support structural members 206 that may be disposed or spaced linearly (i.e., in a straight line) along the elongated body longitudinal axis. Such an arrangement of the pressing support structural members 206 in each set 308a, 308b, 308c facilitates the operator to conveniently slide the wire harness 102 in the elongated body 202, without the pressing support structural members 206 substantially “interrupting” the wire harness slide.

In the exemplary aspect depicted in FIGS. 1-6, each set 308a, 308b, 308c includes three pressing support structural members 206; however, such depiction should not be construed as limiting. Each set 308a, 308b, 308c may include more or less than three pressing support structural members 206, without departing from the present disclosure scope. In some aspects, a count of pressing support structural members 206 in each set 308a, 308b, 308c may be in a range of 2-5. Further, distances between adjacent pressing support structural members 206 in each set 308a, 308b, 308c may be the same.

Furthermore, in the exemplary aspect depicted in FIGS. 1-6, the assembly 100 includes three sets 308a, 308b, 308c; however, such depiction should not be construed as limiting. The assembly 100 may include more or less than three sets, without departing from the present disclosure scope.

In some aspects, distances between adjacent sets 308a, 308b, 308c may be the same. For example, the second set 308b (or the “middle” set) may be equidistant from the adjacent sets 308a, 308c on the elongated body's circumference.

In addition to the elongated body 202 (which provides the wire harness “sliding” feature to the assembly 100) and the plurality of pressing support structural members 206 (which provides the wire harness “pressing” feature to the assembly 100), the assembly 100 may include one or more additional components that may enhance the convenience of an operator using the assembly 100. For example, in some aspects, the assembly 100 may further include an attachment support structural member 208 and one or more straps 210a, 210b (collectively referred to as straps 210), as shown in FIG. 2.

In some aspects, the attachment support structural member 208 may have a planar body (i.e., not a circular or curved body) having a proximal edge and a distal end. The proximal edge of the attachment support structural member 208 may be attached to the first elongated edge 302 of the elongated body 202, as shown in FIG. 3. In some aspects, the length of the proximal edge of the attachment support structural member 208 may be equivalent to the elongated body's length “L”, and hence the proximal edge of the attachment support structural member 208 may be attached to the first elongated edge 302 along the entire length “L” of the first elongated edge 302 (as shown in FIGS. 1-6). In other aspects, the length of the proximal edge of the attachment support structural member 208 may be less than the elongated body's length “L”, and hence the proximal edge of the attachment support structural member 208 may be attached to a portion of the first elongated edge 302 (and not to its entire length).

Further, in some aspects, the proximal ends of the straps 210 may be attached to the second elongated edge 304, as shown in FIG. 3. FIGS. 1-6 depict an exemplary aspect where the assembly 100 includes two straps 210; however, such depiction should not be construed as limiting. The assembly 100 may include more or less than two straps 210, without departing from the present disclosure scope.

The straps 210 and/or the attachment support structural member 208 may be made of the same or different material as the elongated body 202. Furthermore, in some aspects, a distal edge of the planar attachment support structural member 208 may include one or more receptacle structural members 310a, 310b (collectively referred to as receptacle structural members 310) that may include through-holes or openings, which may be configured to receive the distal ends of the straps 210. The straps 210 may be configured to enable the elongated body 202 to tightly secure the wire harness 102 in the elongated body's hollow interior portion when the straps 210 (e.g., their distal ends) are inserted into the receptacle structural members 310 and the straps 210 are locked in the receptacle structural members 310. Specifically, to tightly secure the wire harness 102 in the elongated body's hollow interior portion, an operator may first slide the wire harness 102 to an optimal position in the hollow interior portion and then insert the distal ends of the straps 210 into the receptacle structural members 310. The operator may then pull the straps 210 “downwards” to enable the elongated body 202 to tightly secure the wire harness 102. In some aspects, the operator may pull the straps 210 downwards such that the wire harness 102 is not “too tightly” secured in the elongated body 202 (thereby preventing any adverse situation associated with the wire harness 102 and/or the wires bundled in the wire harness 102). Once the wire harness 102 is tightly secured, the operator may lock the straps 210 in the receptacle structural members 310. In this manner, the combination of the straps 210 and the receptacle structural members 310 enables the operator to conveniently and efficiently secure the wire harness 102 in the elongated body 202 when the wire harness 102 is optimally placed inside the elongated body 202.

In further aspects, the planar body of the attachment support structural member 208 may include a through-hole 212 (shown in FIG. 2) configured to receive the fastener 104 that may attach the assembly 100 to the vehicle body or an external component (e.g., a bracket, sheet metal, etc.). In some aspects, the through-hole 212 may be located at a planar body's center portion, so that the assembly 100 may be robustly and stably attached to the vehicle body / external component via the fastener 104.

To further enhance the user convenience of operating the assembly 100, the assembly 100 may additionally include a plurality of ridges 214a, 214b, 214c, 214n (collectively referred to as ridges 214) formed on the elongated body 202, along an elongated body circumference as shown in FIG. 2. A longitudinal axis of each ridge 214 may be perpendicular to the elongated body longitudinal axis. Further, the ridges 214 may have the same lengths, which may be in a range of 60-100% of the elongated body circumference length “L1”. Furthermore, the distances between adjacent ridges 214 may be the same. In some aspects, the ridges 214 may enable the operator to conveniently hold and attach the assembly 100 to the vehicle body / external component via the fastener 104 and prevent slipping of the assembly 100 from the operator's hands.

In operation, the operator may first insert the fastener 104 into the through-hole 212. The operator may then slide the wire harness 102 into the elongated body's hollow interior portion to an optimal position. Once the wire harness 102 is in the optimal position, the operator may secure the wire harness 102 in the elongated body 202 by inserting and locking the straps 210 in the receptacle structural members 310.

In some aspects, the operator may attach the assembly 100 to the vehicle body/external component via the fastener 104 after sliding the wire harness 102 in the elongated body 202 to the optimal position. In other aspects, the operator may first attach the assembly 100 to the vehicle body/external component via the fastener 104 and then slide the wire harness 102 in the elongated body 202 to the optimal position.

The assembly 100, as disclosed in the present disclosure, provides many advantages over conventional wire harness retainer assemblies. For example, the assembly 100 ensures that the wire harness 102 is not too tightly secured in the elongated body 202, thereby ensuring that the wire harness 102 or the wires are not adversely affected (e.g., due to short circuits or electricity discontinuities). This further increases harness durability during the vehicle's lifecycle. The assembly's sliding feature ensures that manufacturing tolerances are efficiently compensated, and the operator can conveniently slide the wire harness 102 inside the elongated body 202 as per the actual installation requirements/position. Further, the assembly 100 can be easily adapted to secure wire harnesses of different diameters/sizes. Furthermore, any commercial retainer/fastener such as round, oval, Christmas tree retainer, etc. can be used to fix/attach the assembly 100 to any kind of bracket according to the application.

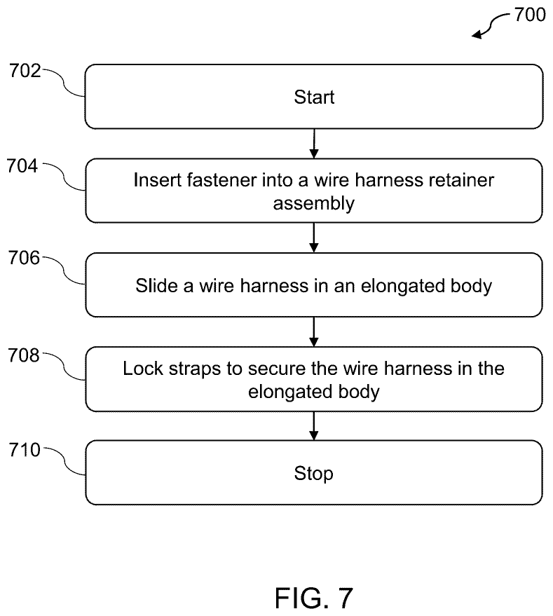

FIG. 7 depicts a flow diagram of an example method 700 to install the wire harness retainer assembly 100 in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include inserting the fastener 104 into the through-hole 212 of the attachment support structural member 208. At step 706, the method 700 may include sliding the wire harness 102 into the elongated body's hollow interior portion to an optimal position, as described above. At step 708, the method 700 may include inserting and locking the straps 210 in the receptacle structural members 310 to secure the wire harness 102 in the elongated body 202.

The method 700 may include an additional step (not shown) of attaching the assembly 100 to the vehicle body/external component via the fastener 104. This additional step may be performed before or after the step 706.

The method 700 may end at step 710.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A wire harness retainer assembly comprising:
a harness sliding structural member having an elongated body with an arc-shaped cross section, wherein the elongated body comprises a hollow interior portion and open proximal and distal ends; and
a plurality of pressing support structural members formed on the elongated body, wherein each pressing support structural member comprises a concave-shaped body curved inwards towards the hollow interior portion.

2. The wire harness retainer assembly of claim 1, wherein the elongated body is configured to enclose a wire harness and enable the wire harness to slide along an elongated body longitudinal axis.

3. The wire harness retainer assembly of claim 2, wherein the concave-shaped body is configured to press and apply an inward pressure on a wire harness circumference to secure the wire harness in the hollow interior portion.

4. The wire harness retainer assembly of claim 1, wherein the arc-shaped cross section has a circumferential length that is equivalent to 60-90% of a complete circular circumference.

5. The wire harness retainer assembly of claim 1 further comprising a plurality of ridges formed along an elongated body circumference, wherein a longitudinal axis of each ridge is perpendicular to an elongated body longitudinal axis.

6. The wire harness retainer assembly of claim 5, wherein distances between adjacent ridges are same.

7. The wire harness retainer assembly of claim 1, wherein the plurality of pressing support structural members comprises one or more sets of pressing support structural members, and wherein each set of pressing support structural members comprises one or more pressing support structural members that are spaced linearly along an elongated body longitudinal axis.

8. The wire harness retainer assembly of claim 7, wherein distances between adjacent pressing support structural members in each set of pressing support structural members are same.

9. The wire harness retainer assembly of claim 7, wherein the plurality of pressing support structural members comprises three sets of pressing support structural members, and wherein a middle set of pressing support structural members is equidistant from adjacent sets of pressing support structural members.

10. The wire harness retainer assembly of claim 7, wherein a count of pressing support structural members in each set of pressing support structural members is in a range of 2-5.

11. The wire harness retainer assembly of claim 1 further comprising an attachment support structural member and one or more straps.

12. The wire harness retainer assembly of claim 11, wherein the elongated body comprises a first elongated edge and a second elongated edge aligned parallel to each other, wherein a proximal edge of the attachment support structural member is attached to the first elongated edge, and wherein proximal ends of the one or more straps are attached to the second elongated edge.

13. The wire harness retainer assembly of claim 12, wherein the proximal edge of the attachment support structural member is attached to the first elongated edge along an entire length of the first elongated edge.

14. The wire harness retainer assembly of claim 12, wherein a distal edge of the attachment support structural member comprises one or more receptacle structural members configured to receive distal ends of the one or more straps, and wherein the one or more straps are configured to enable the elongated body to tightly secure a wire harness in the hollow interior portion when the one or more straps are locked in the one or more receptacle structural members.

15. The wire harness retainer assembly of claim 12, wherein the attachment support structural member has a planar body, and wherein the planar body comprises a through-hole configured to receive a fastener to attach the wire harness retainer assembly to a component of a vehicle.

16. The wire harness retainer assembly of claim 15, wherein the through-hole is located at a center portion of the planar body.

17. The wire harness retainer assembly of claim 1, wherein the elongated body is made of a flexible material.

18. A wire harness retainer assembly comprising:
a harness sliding structural member having an elongated body with an arc-shaped cross section, wherein:
the elongated body comprises a hollow interior portion and open proximal and distal ends,
the elongated body is configured to enclose a wire harness and enable the wire harness to slide along an elongated body longitudinal axis, and
the elongated body is made of a flexible material; and
a plurality of pressing support structural members formed on the elongated body, wherein:
each pressing support structural member comprises a concave-shaped body curved inwards towards the hollow interior portion, and
the concave-shaped body is configured to press and apply an inward pressure on a wire harness circumference to secure the wire harness in the hollow interior portion.

19. The wire harness retainer assembly of claim 18, wherein the arc-shaped cross section has a circumferential length that is equivalent to 60-90% of a complete circular circumference.

20. A wire harness retainer assembly comprising:
a harness sliding structural member having an elongated body with an arc-shaped cross section, wherein the elongated body comprises a hollow interior portion and open proximal and distal ends;
a plurality of pressing support structural members formed on the elongated body, wherein each pressing support structural member comprises a concave-shaped body curved inwards towards the hollow interior portion; and
an attachment support structural member and one or more straps, wherein:
the elongated body comprises a first elongated edge and a second elongated edge aligned parallel to each other,
a proximal edge of the attachment support structural member is attached to the first elongated edge,
proximal ends of the one or more straps are attached to the second elongated edge,
a distal edge of the attachment support structural member comprises one or more receptacle structural members configured to receive distal ends of the one or more straps, and
the one or more straps are configured to enable the elongated body to tightly secure a wire harness in the hollow interior portion when the one or more straps are locked in the one or more receptacle structural members.
